(19) United States
(12) Patent Application Publication
(10) Pub. No.: US 2014/0205971 A1
(43) Pub. Date: Jul. 24, 2014

(54) MODIFICATION OF ROOT FORM DENTAL IMPLANTS FOR ACCELERATED TISSUE REGENERATION

(71) Applicant: THE TRUSTEES OF THE STEVENS INSTITUTE OF TECHNOLOGY, Hoboken, NJ (US)

(72) Inventor: Hongjun Wang, Millburn, NJ (US)

(73) Assignee: THE TRUSTEES OF THE STEVENS INSTITUTE OF TECHNOLOGY, Hoboken, NJ (US)

(21) Appl. No.: 14/158,291

(22) Filed: Jan. 17, 2014

Related U.S. Application Data
(60) Provisional application No. 61/754,137, filed on Jan. 18, 2013.

(51) Int. Cl. A61C 8/00; A61C 13/00

(52) U.S. Cl. CPC A61C 8/0013; A61C 8/0022; A61C 13/0006
USPC 433/174; 427/2.29

(57) ABSTRACT

An endosseous dental implant for guided regeneration of gingival tissue onto the implant and method of producing the same is prepared by coating a region of the implant with biocompatible, random or aligned microfibers or nanofibers to which gingival epithelial and connective tissue cells may become attached. The fibers may be degradable or nondegradable. The extracellular matrix of new connective tissue forms and connects to the implant surface, guided by the nanofibers or microfibers. The coated implant prevents bacterial biofilm formation, which can cause detrimental resorption of crestal bone and lead to implant failure. The implant surface supports improved tissue bonding and provides a cost-effective approach to coating the dental implant surface with biomimetic fibers to enhance gingival or other tissue regeneration directly onto the implant surface.

### CROSS-REFERENCE TO RELATED APPLICATIONS

This application claims priority to U.S. Provisional Application Ser. No. 61/754,137 filed on Jan. 18, 2013, the disclosure of which is incorporated by reference herein.

### FIELD OF THE INVENTION

The present invention relates to medical implants and, more particularly, to dental implants with surface modifications.

### BACKGROUND OF THE INVENTION

Dental implants are widely used to replace damaged or missing teeth. A majority of the dental implants which are implanted today are endosseous implants, also known as root form implants. Current endosseous dental implants are generally made of commercially pure titanium or titanium alloy, mainly due to the biocompatibility, lower stress-shielding and, most importantly, osseointegration qualities of titanium.

Osseointegration refers to the quality of a material that promotes direct attachment of bone to the material. Osseointegration is desirable as it decreases the likelihood that the patient's body will reject the implant thereby reducing the strength and stability of the implant's fixation into bone. As a result, the possibility of failure during functional loading (e.g., chewing) would be increased.

Certain modifications have achieved success in forming a functional connection between bone and the implant's surface. However, this connection is not permanent as the fixation strength will degrade over time. Loss of fixation strength is commonly caused by bone degradation around the surface of the implant as a result of infections caused by biofilms. The problem is relatively common because, even though bone tissue will grow onto and fixate the implant when a dental implant is installed, gum tissue (i.e., gingiva) does not grow onto or adhere to the implant surface. Lack of adhesion to the implant's surface leaves a gap, which can trap bacteria and food debris and provide a favorable environment for bacterial growth, thereby leading to increased biofilm formation. As the biofilm forms and infects the immediate area, the environment can deteriorate the bone adjacent to the infected area (i.e., crestal bone) thereby compromising implant fixation and potentially leading to failure. Persistent biofilm formation results in periodontal diseases such as periodontitis, which is characterized by tissue degeneration and antibiotic-resistance that challenges the host defense. Small molecules such as growth factors, antibiotics or other biomolecules provided on an implant's surface can help combat the deleterious effects of biofilm and gingival detachment, and promote the growth of tissue.

However, commercial dental implant modifications are expensive, cause defects in the implants, or increase risk of infection due to the difficulty of retaining sterility. Additionally, current modifications fail to properly maintain and regenerate gingiva onto crestal bone and implant surfaces, which is believed to play an important role in maintaining the osseointegration of dental implants, while retaining necessary dental aesthetics.

### SUMMARY OF THE INVENTION

In an embodiment of the present invention, a method of making a dental implant having a fiber-coated cervical location for implantation into a patient's jaw for guiding gingival tissue growth comprises the steps of preparing an electrospinning solution including a synthetic polymer and at least one substance selected from the group consisting of chitosan, collagen, extracellular matrix proteins, antibiotics, growth factors, and small molecules, electrically grounding the dental implant, and electrospinning at least one fiber from the electrospinning solution and depositing the at least one fiber on the cervical location of the dental implant while rotating the cervical location of the dental implant, thereby depositing aligned fibers on the cervical location of the dental implant, wherein the at least one fiber is at least one nanofiber or at least one microfiber.

In an embodiment, a biomimetic fiber-coated dental implant comprises a threaded root portion, wherein the root portion includes a distal narrow end and a wide end opposite the distal end, the wide end having a proximal circular ring and a distal circular ring, the proximal and distal circular rings defining an abutment region having a cervical location, wherein the wide end includes a slot having at least one indentation, and wherein the cervical location is coated with biomimetic fibers, the biomimetic fibers including at least one biomolecule selected from the group consisting of chitosan, collagen, extracellular matrix proteins, antibiotics, growth factors, and small molecules.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a schematic illustration of a dental implant to be modified by a fiber coating according to an embodiment of the present invention;

FIG. 2 is a schematic illustration of the dental implant of FIG. 1 inserted into the crestal bone region of a patient's jawbone;

FIG. 3 is a schematic illustration of an enlarged cut-out view of a portion of the dental implant of FIG. 1 after insertion into a patient's jawbone;

FIG. 4 is a flowchart of a method of coating a dental implant according to an embodiment of the present invention;

FIG. 5A is a scanning electron microscope (SEM) image of a first nanofiber scaffold having random nanofibers according to an embodiment of the present invention;

FIG. 5B is an SEM image of a second nanofiber scaffold having aligned nanofibers according to an embodiment of the present invention;

FIG. 6 is a schematic illustration of a cut-out portion of a dental implant according to an embodiment of the present invention depicting cell growth on an aligned nanofiber scaffold;

FIG. 7 is an SEM image of the randomly aligned nanofiber scaffold depicted in FIG. 5A;

FIG. 8 is an SEM image of fibroblast morphology showing the increased growth of cells as indicated by increased expression of F-actin on the nanofiber scaffold of FIG. 5A;

FIG. 9 is an SEM image of fibroblast morphology showing the increased growth of cells as indicated by increased expression of α-tubulin on the nanofiber scaffold of FIG. 5A;

FIG. 10 is an SEM image of the randomly aligned nanofiber scaffold of FIG. 5B;

FIG. 11 is an SEM image of fibroblast morphology showing the increased growth of cells as indicated by increased expression of F-actin on the nanofiber scaffold of FIG. 5B;

FIG. 12 is an SEM image of fibroblast morphology showing the increased growth of cells as indicated by increased expression of α-tubulin on the nanofiber scaffold of FIG. 5B;

FIG. 13A is an SEM image showing the extent of cell migration on a random nanofiber mesh over a 3 day period;

FIG. 13B is an SEM image showing the extent of cell migration on an aligned nanofiber mesh over a 3 day period;

FIG. 13C is a bar graph quantifying the distance fibroblasts migrated on random fiber meshes and in the parallel and perpendicular directions to the fiber alignment on aligned fiber meshes;

FIG. 14A is a plot of the cumulative concentration of biomolecules released from both microfiber and nanofiber scaffolds;

FIG. 14B is a plot of the cumulative release amount as a percentage of total amount of biomolecules loaded in both microfiber and nanofiber scaffolds; and

FIG. 14C is a plot of the release rate of biomolecules from both microfiber and nanofiber scaffolds.

### DETAILED DESCRIPTION OF THE EXEMPLARY EMBODIMENT

The present invention will now be described with reference to a particular dental implant prepared according to embodiments of the present invention. It should be understood that this description is merely exemplary and is not limiting as to the scope and spirit of the invention. One of ordinary skill in the art will recognize that other implants, compositions and methods of preparation and use are possible and that such other implants, compositions and methods are intended to fall within the scope of the present invention.

The present invention relates to dental implants coated with biomimetic nanofibers to form a nanofiber scaffold (also referred to herein as nanofiber mesh). The nanofibers may incorporate biomolecules such as, for instance, chitosan, collagen, extracellular matrix proteins, antibiotics, growth factors, inorganic particles or other bioactive agents known in the art to further enhance tissue growth and prevent infection. Nanofibers may be deposited on the surface of the dental implant in certain alignments in order to promote both tissue and bone growth in the desired areas. In some embodiments, a microfiber scaffold is used.

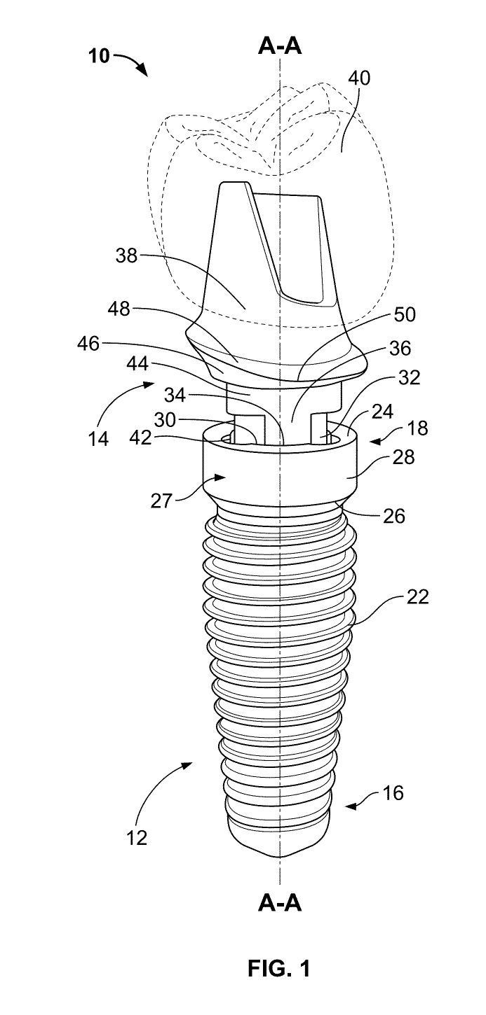

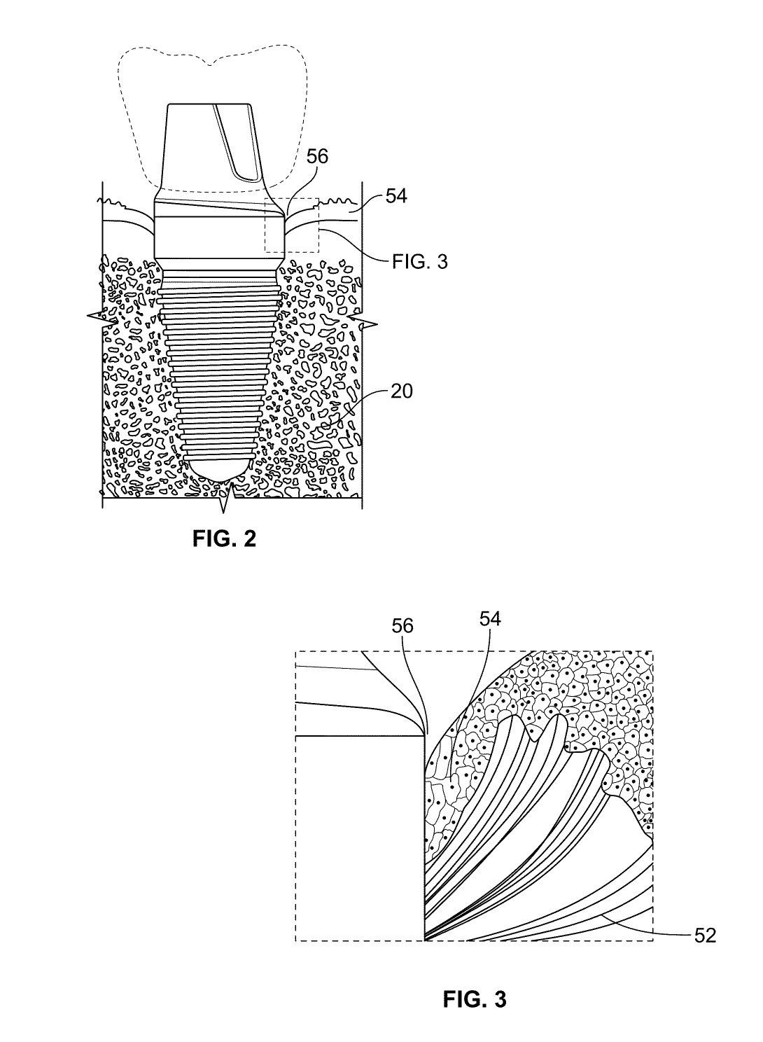

FIGS. 1-3 are schematic illustrations of a dental implant 10 to be prepared according to an embodiment of the present invention. With reference to FIG. 1, implant 10 includes a generally screw-like root portion 12 and a generally cylindrical connection element 14. Root portion 12 includes a distal narrow end 16 and a wide end 18 opposite distal end 16 and adjacent the connection element 14. Root portion 12 is configured to be installed into a crestal bone region 20 of the jawbone of a patient such that the root portion 12 may extend through the gum tissue of a patient and sufficiently far into the jawbone to provide strength and stability to the implant 10 (see FIG. 2). Root portion 12 may include threads 22 to further facilitate installation and retention in a patient's jawbone.

Wide end 18 includes a proximal circular ring 24 and a distal circular ring 26 opposite proximal circular ring 24. Proximal and distal circular rings 24, 26 define an abutment region 27 having a cervical location 28. A slot 30 with an interior surface 32 is provided in an interior region 34 of the wide end 18 and is configured to accept the connection element 14. In an embodiment, interior surface 32 may be provided with female threads (not shown) to facilitate connection with connection element 14 or may be configured with other attachment methods known in the art (i.e., press-fit, adhesive, etc.). In an embodiment, connection element 14 may be formed integrally with root portion 12. The root portion 12 and connection element 14 are generally made of titanium, commercially pure titanium alloy or any other suitable material known in the art.

To facilitate understanding of the invention, FIG. 1 depicts the connection element 14 slightly withdrawn from the root portion 12. In an embodiment, connection element 14 includes a generally cylindrical base 36 adapted to be inserted into the slot 30 of the root portion 12, and a prosthetic end 38 opposite the cylindrical base 36 which is adapted to receive a dental prosthetic 40 (i.e., a crown, denture, bridge, etc.). In an embodiment, prosthetic end 38 may be provided in any configuration known in the art. In an embodiment, slot 30 may include at least one indentation 42 which communicates with corresponding protrusions 44 of the connection element 14 to ensure proper orientation and alignment. In an embodiment, connection element 14 may include a circular region 46 to enhance formation of a tight seal when the connection element 14 is connected to the root portion 12. In an embodiment, connection element 14 further includes a cap 48 configured to support the growth of gingival tissue 54 to provide a natural appearance. In an embodiment, cap 48 may be formed with a flange 50 to better retain attachment of the gingival tissue 54.

An example of a dental implant 10 suitable for use with the present invention is sold by BioHorizons IPH, Inc. (Birmingham, Ala.) under the trademark Laser-Lok™. It should be understood that any commercial dental implant may be suitably used in accordance with the present invention without departing from the scope of the claims.

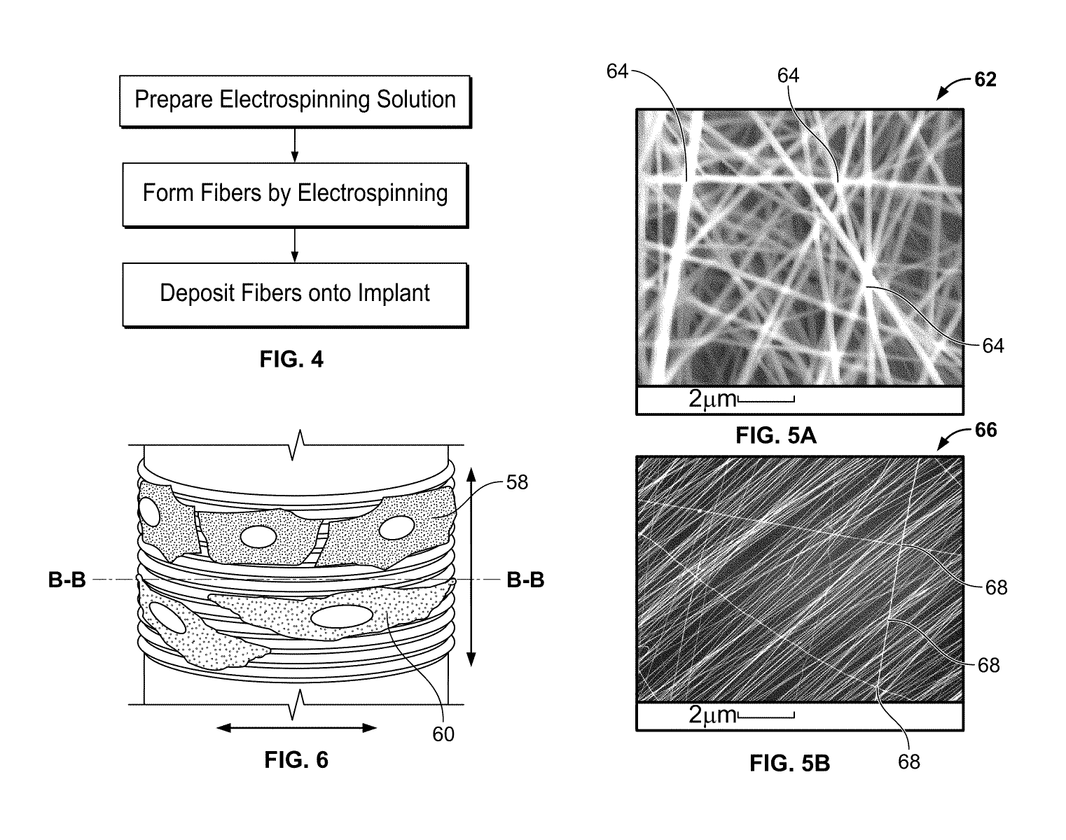

Preparation of an electrospinning solution will now be described with reference to FIG. 4, which is a flowchart depicting the steps of depositing biomimetic nanofibers on a dental implant. Here, “biomimetic” means any natural or manmade fiber or material that mimics a substance normally found within the body. Referring to FIG. 4, an electrospinning solution is prepared according to techniques commonly known in the art. In an embodiment, the electrospinning solution may be made from any synthetic polymer such as, for instance, polycaprolactone (“PCL”), poly(lactic-co-glycolic) acid (“PLGA”) or other suitable polymers known in the art. In an embodiment, the electrospinning solution may be made from other materials such as a metal slurry. In an embodiment, the electrospinning solution may contain biomolecules (i.e, small molecules) such as, for instance, chitosan, collagen or other extracellular matrix components, antibiotics, growth factors, inorganic particles or other small molecules or bioactive agents known in the art. In an embodiment, the coating may be degradable. In an embodiment, the coating may be nondegradable. Once a desired electrospinning solution is formed, the solution is transferred to a syringe or the like (i.e., an electrostatic spinning vessel).

In an embodiment, biomimetic nanofibers are coated onto the cervical location 28 of the dental implant 10 using conventional electrostatic spinning (“electrospinning”) techniques known in the art such as described in Yang, X. et al., Journal of Experimental Nanoscience, Vol. 3, No. 4, 329-345 (2008). The process of electrospinning involves applying a high voltage to a syringe tip, which causes a solution within the syringe to travel through an electrical field and to deposit on an electrically-grounded collector as a fiber. More particularly, in an embodiment of the present invention, a polymer solution is placed into the syringe and electrospun onto a dental implant 10, which acts as the grounded collector. Electrospinning parameters, such as electrospinning solution flow rate, voltage across the syringe tip and collector, and distance between the syringe tip and the collector (“collection distance”), may be selected to produce microfibers or nanofibers having the selected fiber diameters.

In an embodiment, the dental implant 10 remains static during the electrospinning process in order to form a random nanofiber scaffold 62 (see FIG. 5A) with randomly deposited nanofibers 64. In an embodiment, the dental implant 10 is rotated around axis line A-A (see FIG. 1) during the electrospinning process in order to form an aligned nanofiber scaffold 66 (see FIG. 5B) with aligned nanofibers 68 oriented perpendicular to axis line A-A. As seen in FIG. 6, epithelial cells 58 and fibroblast cells 60 proliferate parallel to the alignment of the fibers which is shown by the dashed line B-B.

In an embodiment of the electrospinning process, the polymer solution has a flow rate of about 10 μL/min. The collection distance is about 100 mm to about 120 mm from the syringe tip. The dental implant is spun at a rate of about 75 cycles/min to about 80 cycles/min. A voltage in the range of about 10 kV to about 15 kV is applied to the syringe. In an embodiment, the flow rate of polymer solution, the collection distance and voltage intensity are manipulated to form microfibers (i.e., 1-30 μm) or nanofibers (i.e., 1-1000 nm). In an embodiment, fibers may be deposited above or below the cervical location 28 to control the growth of gingival tissue. More particularly, fibers can be deposited on the root portion 12 below the cervical location 28 in an alignment that is perpendicular to axis line A-A in order to halt the growth of gingival tissue 54. This, in turn, helps to prevent the gingival tissue 54 (see FIG. 3) from interfering with bone attachment to implant 10. In an embodiment, biomimetic fibers configured to enhance growth of bone tissue may be deposited along the root portion 12, in a random or aligned manner. In an embodiment, fibers may be deposited on a dental implant 10 by near-field electrical deposition (e.g., about 1-5 mm collection distance). In an embodiment, such method may be manipulated to form nanofibers or microfibers exhibiting controlled alignment (i.e., orientation) and textures. In an embodiment, other techniques known in the art may be applied.

The present invention provides numerous advantages over pre-existing dental implants. For instance, in an embodiment, deposition of biomimetic nanofibers onto the cervical location 28 of dental implants 10 has been shown to enhance gingival tissue 54 growth on the implant 10, which helps to prevent entry of bacteria in a gap 56 (see FIG. 3) between the implant 10 and gingival tissue 54. This, in turn, prevents biofilm formation (a disease often identified as gingivitis) and bone degradation due to infection. In an embodiment, biomimetic nanofibers may be advantageously employed to block growth of gingival tissue cells and enhance the growth and attachment of bone to the root portion 12 of the implant 10.

Without being bound by theory, it is believed that electrospun fibers exhibit a structure which mimics the structure of the gingival connective tissue matrix 52 (see FIG. 3). As a result, the migration, proliferation, and cell adhesion of gingival fibroblasts 60 to the fiber surface is enhanced, which leads to rapid formation of new gingival tissue 54. It is an additional advantage that the nanofibers may be aligned for controlled regeneration of gingiva onto a dental implant 10 without migration down to the osseous root. As such, the risk of bone detachment is lowered, thereby providing the dental implant 10 greater stability within an implant site.

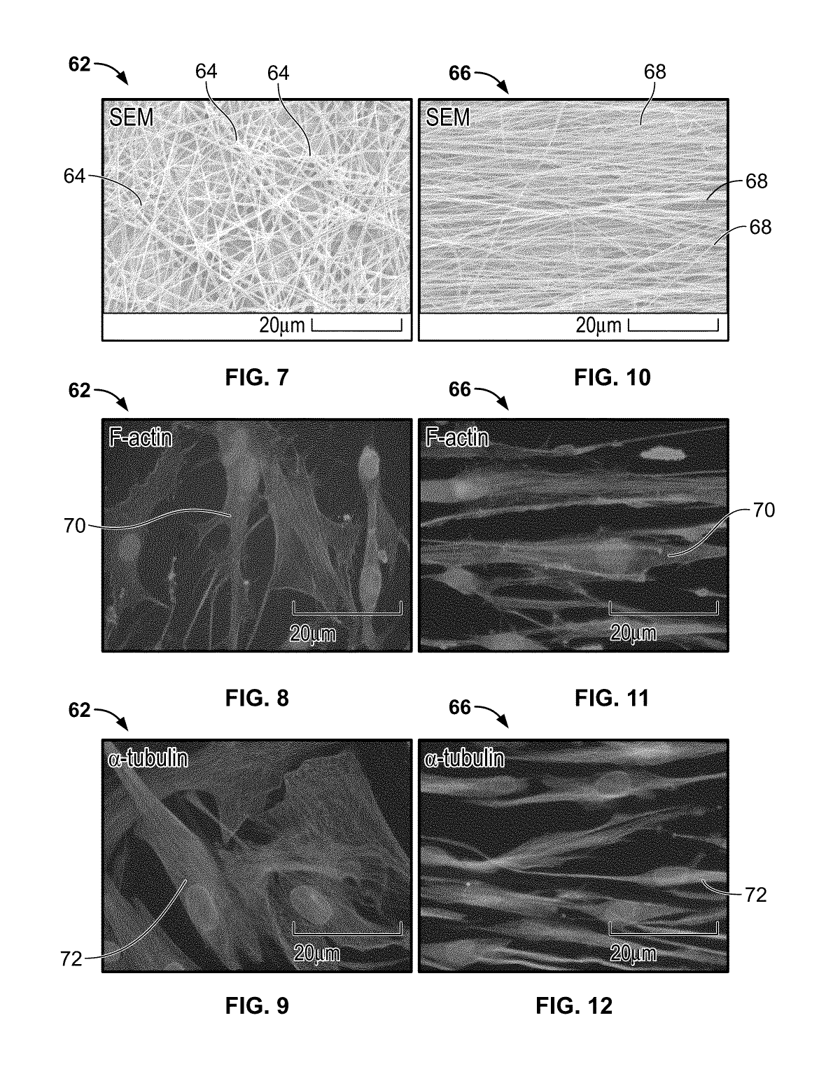

FIGS. 7-12 illustrate nanofiber orientation and fibroblast morphology on nanofiber scaffolds. The fibers 64 in FIGS. 7-9 are randomly oriented, while the fibers 68 in FIGS. 10-12 are arranged in a horizontal orientation. More particularly, FIGS. 7 and 10 show nanofiber scaffolds 62, 64, FIGS. 8 and 11 show the increased growth of cells as indicated by increased expression of F-actin 70, and FIGS. 9 and 12 show the increased growth of cells as indicated by increased expression of α-tubulin 72. In the example shown, cells cultured for 24 hours on nanofiber scaffolds 62, 66, then fixed and stained with phalloidin-TRITC (i.e., a rhodamine dye) for F-actin 70 and FITC-conjugated-anti-α-tubulin antibody (i.e., DSHB) for α-tubulin 72. The magnification in FIGS. 7-12 is 40×. Fibroblasts cultured on random and aligned biomimetic nanofibers scaffolds 62, 68 show different morphologies (i.e., the fibroblasts are elongated in the direction of alignment on the aligned fiber meshes 66, however, no obvious elongation of cells on the random fiber meshes 62 was observed). Intracellular cytoskeletal fibers were also elongated in the same direction. A tight bonding of biomimetic nanofibers 64, 68 onto Ti alloy was observed for both aligned and random fibers 64, 68. Thus, biomimetic electrospun fibers 64, 68 can promote adhesion and growth of gingival cells, as well as the cytoskeletal fiber organization along the fiber alignment but with limited migration perpendicular to the alignment.

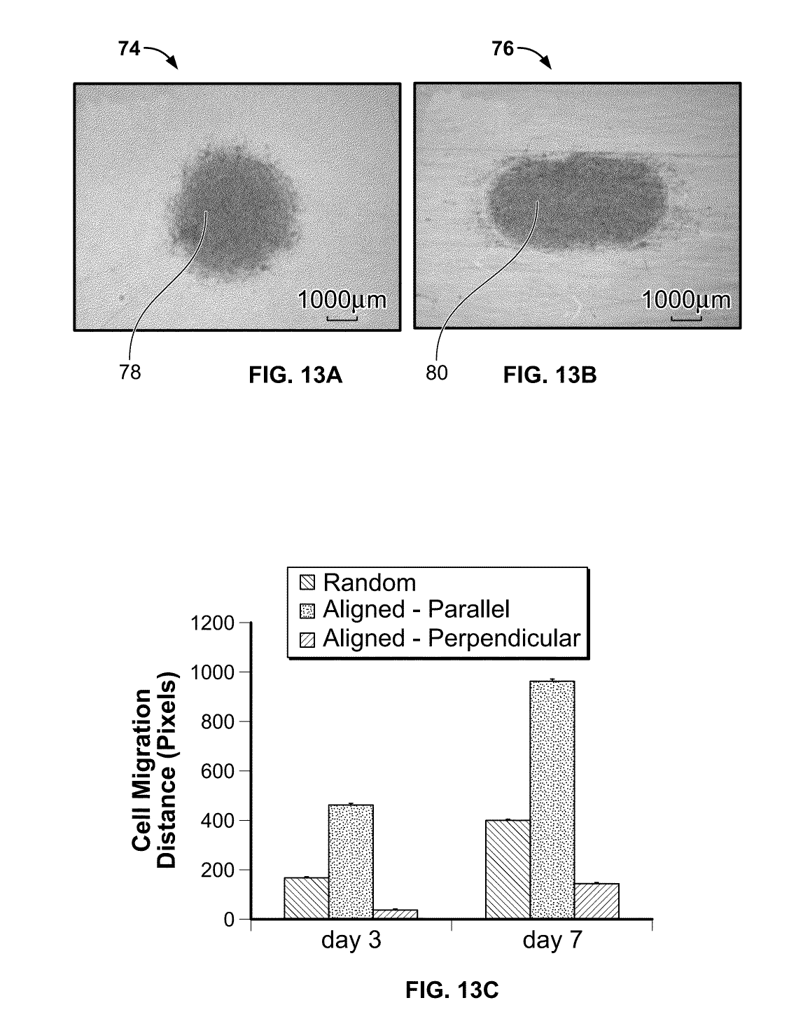

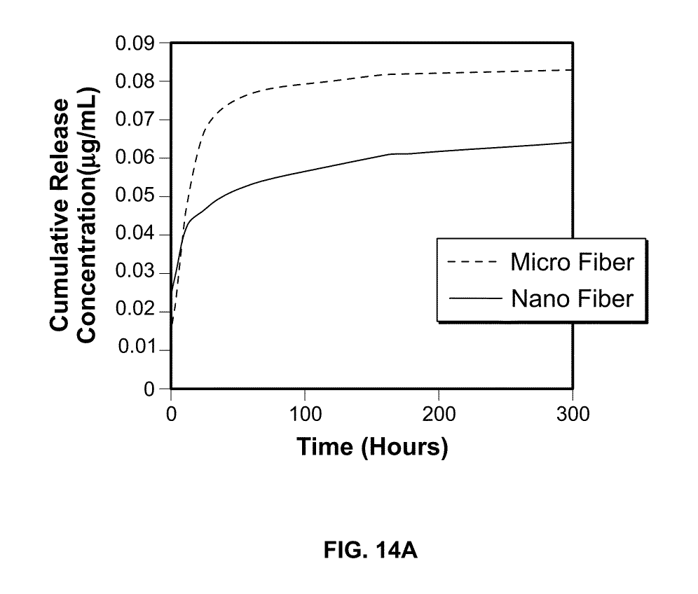

FIGS. 13A and 13B show the migration of fibroblasts 78, 80 on nanofiber meshes 74, 76, respectively. In the example shown, cells cultured on a nanofiber mesh for 3 days were fixed and stained with methylene blue. FIG. 13C depicts the length of cell migration from the center of the culture, for both random fiber and aligned fiber meshes (i.e., FIGS. 13A and 13B, respectively) shown for “day 3”. It was found that fibroblasts grew to cover a larger area (i.e., migrated faster) in the given time period on the aligned fibers than on the random fibers. On the aligned fibers, accelerated proliferation of fibroblasts was also observed. Conversely, migration perpendicular to the orientation of the aligned fibers was slowed.

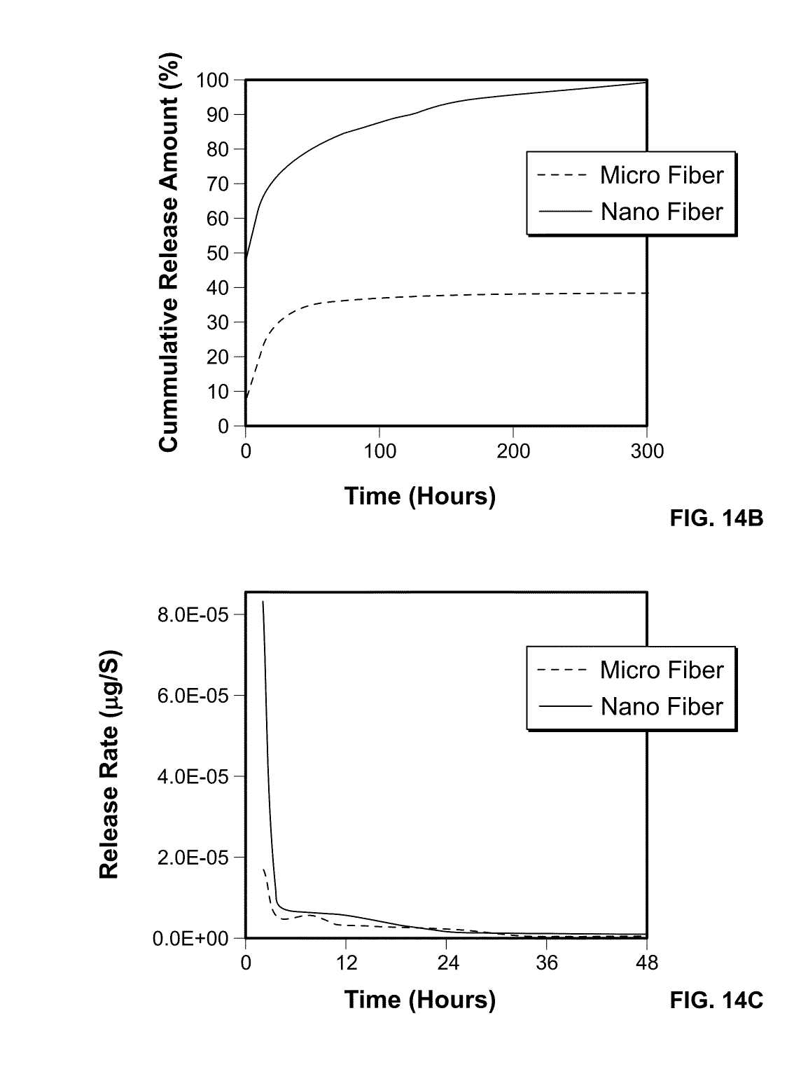

FIGS. 14A, 14B, and 14C are plots that quantify the release of biomolecules from the biomimetic fiber scaffold. In an example, both microfiber and nanofiber scaffolds were tested for release rates and concentrations of Bovine Serum Albumin. As can been seen from FIGS. 14A and 14B, microfiber scaffolds are capable of containing larger concentrations of biomolecules but a lower percentage of that concentration is released as compared to the nanofiber scaffolds. FIG. 14C shows that the rate of release from nanofiber scaffolds is higher than the rate of release from microfiber scaffolds.

It will be understood that the embodiment described herein is merely exemplary and that a person skilled in the art may make many variations and modifications without departing from the spirit and scope of the invention. For instance, all such variations and modifications, in addition to those described above, are intended to be included within the scope of the invention as described in the appended claims.

What is claimed is:

1. A method of making a dental implant having a biomimetic fiber-coated cervical location for implantation into a patient's jaw for guiding gingival tissue growth, said method comprising the steps of:
preparing an electrospinning solution including a synthetic polymer and at least one substance selected from the group consisting of chitosan, collagen, extracellular matrix proteins, antibiotics, growth factors, and small molecules;
electrically grounding the dental implant; and
electrospinning at least one fiber from the electrospinning solution and depositing the at least one fiber on the cervical location of the dental implant while rotating the cervical location of the dental implant, thereby depositing aligned fibers on the cervical location of the dental implant, wherein the at least one fiber is at least one nanofiber or at least one microfiber.

2. A biomimetic fiber-coated dental implant, comprising:
a threaded root portion, wherein the root portion includes a distal narrow end and a wide end opposite the distal end, the wide end having a proximal circular ring and a distal circular ring, the proximal and distal circular rings defining an abutment region having a cervical location, wherein the wide end includes a slot having at least one indentation, and wherein the cervical location is coated with biomimetic fibers, the biomimetic fibers including at least one biomolecule selected from the group consisting of chitosan, collagen, extracellular matrix proteins, antibiotics, growth factors, and small molecules.
